(19) United States
(12) Patent Application Publication
(10) Pub. No.: US 2007/0252013 A1
(43) Pub. Date: Nov. 1, 2007

(54) FREEZEFREE VALVE

(76) Inventor: Carl Hengstebeck, Livonia, MI (US)

Correspondence Address: Kenneth I. Kohn;Kohn & Associates, PLLC, Suite 410, 30500 Northwestern Highway, Farmington Hills, MI, 48334, US

(21) Appl. No.: 11/742,653

(22) Filed: May 1, 2007

Related U.S. Application Data
(60) Provisional application No. 60/746,071, filed on May 1, 2006.

(51) Int. Cl. F16T 1/08; G05D 23/02

(52) U.S. Cl. 236/59; 236/101 R

(57) ABSTRACT

A freeze resistant pipe assembly including a pipe T having a valve mechanism for draining fluid from the pipe T defining a fluid flow path therethrough, wherein the valve mechanism is operatively connected to a bottom portion of the pipe T and below the fluid flow path, and further including a drain operatively connected to the pipe T below the valve mechanism.

### CROSS-REFERENCE TO RELATED APPLICATIONS

This application claims the benefit of priority under 35 U.S.C. Section 119(e) of U.S. Provisional Patent Application No. 60/746,071, filed May 1, 2006, which is incorporated herein by reference.

### BACKGROUND OF THE INVENTION

(1) Field of the Invention

The present invention relates to pipes and plumbing. In particular, the present invention relates to the prevention of bursting pipes due to freezing.

(2) Description of Related Art

The second largest type of insurance claim for damage to homes is water damage. One of the major contributors to that damage is the bursting of pipes in freezing weather. Pipes burst not just from the formation of ice inside the pipe, but from a build-up of pressure downstream caused by the ice blockage. In the northern climates, this is certainly an issue where temperatures can be at or below 32 degrees Fahrenheit for several months of the year.

Generally, pipes are located inside a house or building with insulation for this reason, but pockets of cold air due to cracks in the wall and extremely cold spells can cause a pipe to burst. This is also an issue in warmer southern climates, because pipes are located on the outside of buildings or are not surrounded by insulation in order to keep the building cooler in extremely hot temperatures. While not often, the warmer climates will experience a few nights of freezing weather and there is likely to be a problem with pipes bursting. While the material with which the pipe is made can be a factor of its susceptibility to bursting, it is relatively small compared to the effect of cold air on a pipe.

Several solutions are available to prevent pipes from bursting. For example, insulation can be wrapped around exposed pipes and cracks in walls can be sealed. U.S. Pat. No. 4,883,082 to Pirkle discloses a temperature-responsive valve comprising a pair of wax-filled thermal actuators connected in series and set to expand at different temperatures respectively at the high and low limits of a temperature range and can block the path of flow. Also, U.S. Pat. No. 5,228,469 to Otten, et al. discloses a fluid control device combining a flow sensing unit in series with a control valve including a microprocessor for monitoring parameters including pressure, flow rate, temperature and flow volume, and is enabled to activate the control valve to the open or shut positions based upon any combination of the monitored parameters. This device also blocks the path of flow of a liquid. However, it would be useful to have a design of pipe itself that can prevent such bursting from occurring, as well as a design that does not completely block the flow of liquid inside the pipe.

### BRIEF SUMMARY OF THE INVENTION

The present invention provides for a freeze resistant pipe assembly including a pipe T having a valve mechanism for draining fluid from the pipe T defining a fluid flow path therethrough, wherein the valve mechanism is operatively connected to a bottom portion of the pipe T and below the fluid flow path, and further including a drain operatively connected to the pipe T below the valve mechanism.

### BRIEF DESCRIPTION OF THE DRAWINGS

Other advantages of the present invention will be readily appreciated as the same becomes better understood by reference to the following detailed description when considered in connection with the accompanying drawing, wherein:

FIGS. 1A-1B are cross-sectional views of an embodiment of the freeze resistant pipe assembly wherein 1A shows the assembly in a fluid environment above 35 degrees Fahrenheit, and 1B shows the assembly in a fluid environment at 35 degrees Fahrenheit and below;

FIGS. 2A-2D are views of the T and drain of the freeze resistant pipe assembly, wherein 2A shows a top view of the drain, 2B shows a cross-section of the T and drain junction, 2C shows a cross-section of the drain, and 2D shows a cross-section of the T and drain; and

FIG. 3 is a cross-sectional view of the freeze resistant pipe assembly.

### DETAILED DESCRIPTION

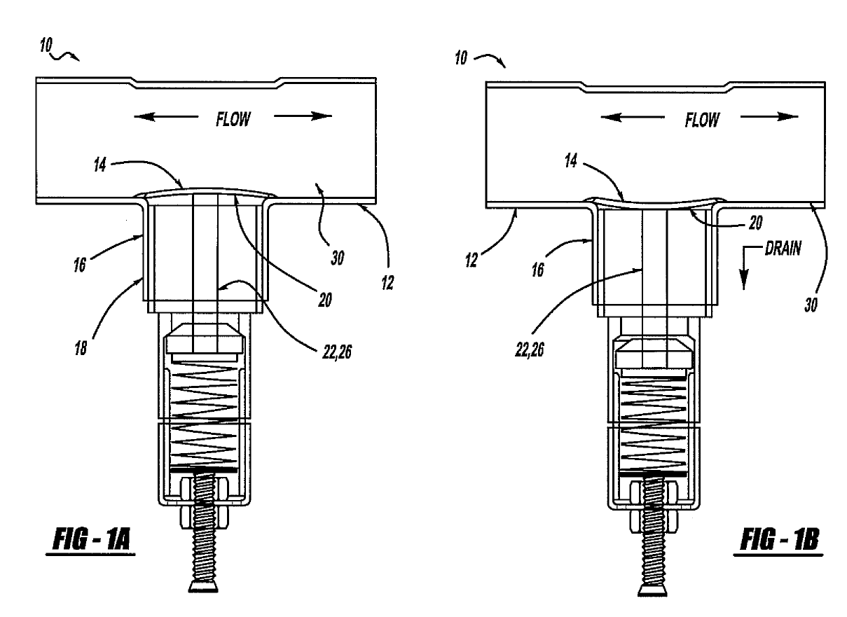

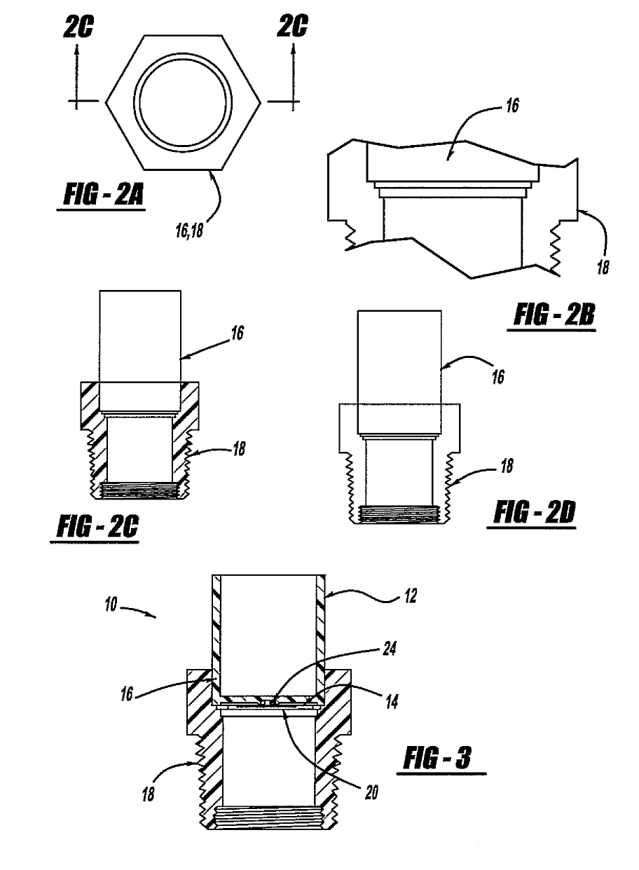

The present invention provides a new and improved apparatus for the prevention of pipe bursting due to freezing conditions. As shown generally in FIGS. 1A-B, 2A-2D, and 3, a freeze resistant pipe assembly 10 is provided of a pipe T 12 including a valve mechanism 14 for draining fluid from the pipe T 12 defining a fluid flow path 30 therethrough, wherein the valve mechanism 14 is operatively attached to a bottom portion 16 of the pipe T 12 and below the flow of fluid, and further including a drain 18 operatively attached to the valve mechanism 14.

The pipe T 12 can be any suitable pipe T, and is manufactured out of materials and methods known in the art. For example, the pipe T 12 can be copper or any other suitable material. The pipe T 12 can be manufactured in various sizes to fit any variety of pipes. The pipe T 12 contains the bottom portion 16 where fluid can flow out of upon activation of the valve mechanism 14. During normal operation, fluid flows through the fluid flow path 30 of the pipe T 12.

The valve mechanism 14 includes a bimetallic actuating sensor 20 operatively attached to a mechanical valve 22, the bimetallic actuating sensor 20 being situated in the bottom portion 16 of the pipe T 12 and in the flow of fluid. The bimetallic actuating sensor 20 is manufactured according to methods known in the art from two metals with different expansion rates. An O-ring 24 is included for sealing any space between the pipe T 12 and the valve mechanism 14, as shown in FIG. 3. The bimetallic actuating sensor 20 is operatively attached to a solenoid valve 26. In this embodiment, the solenoid valve 26 is a normally open type of solenoid, so that in the event of a power failure, the default mode would be open to ensure that freezing does not occur in the pipe.

The drain 18 is operatively connected to the pipe T 12 below the valve mechanism 14 to affect a seal. The drain 18 is in the shape of a pipe and leads to a water collection unit or can be recycled back into a pipe system.

The freeze resistant pipe assembly 10 can be made to fit any various size and type of pipes, and is not limited to use in a pipe T 12. For example, the freeze resistant pipe assembly 10 can be used in a straight pipe or an elbow pipe. Furthermore, the freeze resistant pipe assembly 10 is not limited to use with piping in buildings and homes, but can be used in any other piping system.

The fluid flowing through the freeze resistant pipe assembly is preferably water, however, any other fluid where temperature control is desired can also be used. Therefore, while water is specifically described below, it is contemplated that any other fluid can also be used in the same manner.

In operation, water flowing through the pipe T 12 contacts the bimetallic actuating sensor 20. When the water temperature is above 35 degrees Fahrenheit, the bimetallic actuating sensor 20 allows for normal flow through the pipe T 12, and the mechanical valve 22 remains in a closed position, as shown in FIG. 1A. When the temperature of the water reaches 35 degrees Fahrenheit, the bimetallic actuating sensor 20 actuates the mechanical valve 22, causing it to move to an open position to allow water to flow down the drain 18, as shown in FIG. 1B. The continuous movement of water prevents the water from freezing and thus prevents the pipe from bursting in freezing conditions. The water can drain into a storage tank, or in buildings with their own well system, the water can drain directly into a well. Once the temperature of the water rises to above 35 degrees Fahrenheit, the bimetallic actuating sensor 20 actuates the mechanical valve 22 to move to the closed position, stopping the drainage of water.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. A freeze resistant pipe assembly comprising:
a pipe T including valve means for draining fluid from said pipe T defining a fluid flow path therethrough, wherein said valve means is operatively connected to a bottom portion of said pipe T and below the fluid flow path, and further including a drain operatively connected to said pipe T below said valve means.

2. The freeze resistant pipe assembly according to claim 1, wherein said valve means is a bimetallic actuating sensor operatively attached to a mechanical valve.

3. The freeze resistant pipe assembly according to claim 1, wherein said valve means is a bimetallic actuating sensor operatively attached to a solenoid valve.

4. A method of preventing pipes from freezing, including the steps of:
flowing fluid through the fluid flow path of the pipe T of claim 1;
opening the valve means below the flow of fluid in the pipe T;
draining fluid through the valve means and through the drain to prevent freezing of the fluid in pipes.

5. The method of claim 4, wherein the actuating step is further defined as actuating a bimetallic actuating sensor operatively attached to a mechanical valve.

6. The method of claim 4, wherein the actuating step is further defined as actuating a bimetallic actuating sensor operatively attached to a solenoid valve.

7. The method of claim 4, wherein the valve means is activated at 35 degrees Fahrenheit and the fluid is water.

8. The method of claim 4, wherein the draining step is further defined as draining water into the group consisting of a tank, a well, or a recycle system.
